(19) United States
(12) Patent Application Publication
(10) Pub. No.: US 2008/0218377 A1
(43) Pub. Date: Sep. 11, 2008

(54) Cathodic Integrety Monitor

(76) Inventor: Martin S. Klaiber, Colorado Springs, CO (US)

Correspondence Address: HANES & SCHUTZ, LLC, 102 SOUTH TEJON ST., SUITE 800, COLORADO SPRINGS, CO, 80903, US

(21) Appl. No.: 11/684,450

(22) Filed: Mar. 9, 2007

(51) Int. Cl. G08C 19/00

(52) U.S. Cl. 340/870.03

(57) ABSTRACT

A monitoring system monitors input levels. The monitoring system includes a meter, a local storage system, a processing system, and a transmitter. The meter is configured to periodically measure the input levels. The local storage system is configured to record the measured input levels as data values. The processing system is configured to calculate statistical representations of the data values. The transmitter is configured to transmit the statistical representations.

### BACKGROUND OF THE INVENTION

Cathodic protection is a process whereby a charge is induced on a metallic pipe to inhibit corrosion of the pipe. It is a common practice to periodically monitor the cathodic protection process to ensure that it remains operable.

### DESCRIPTION OF THE DRAWINGS

FIG. 1 is block diagram of one embodiment of the present invention monitoring system.

FIG. 2 is a flow chart showing one embodiment of the present invention method for monitoring input levels.

### DETAILED DESCRIPTION OF THE INVENTION

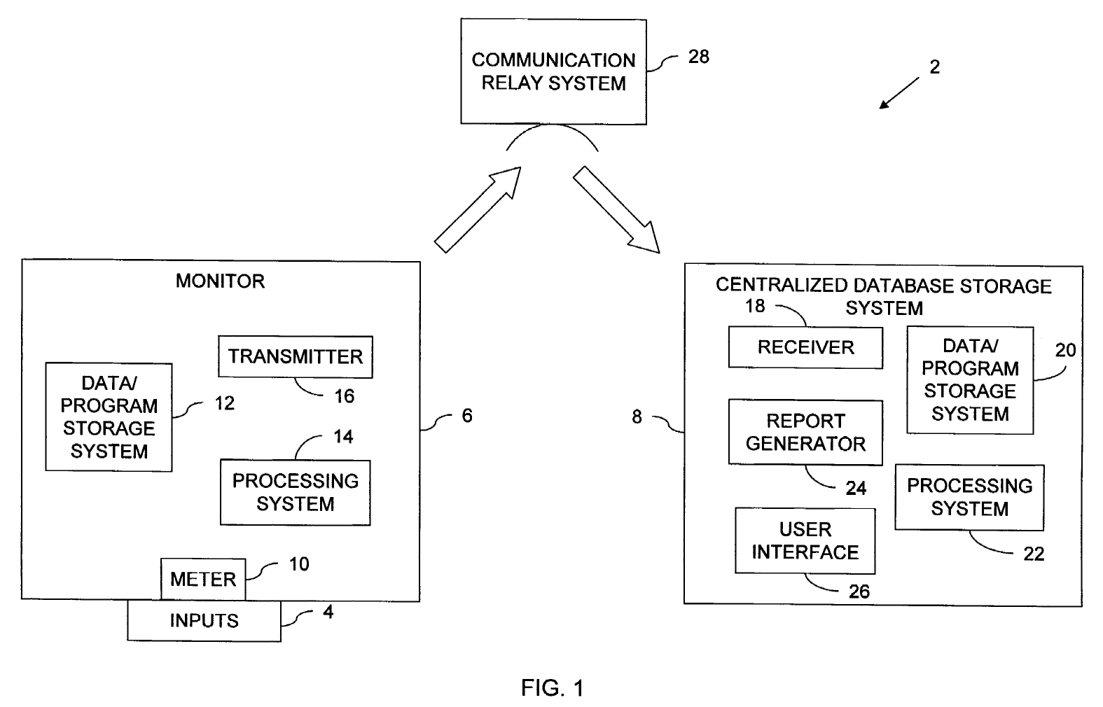

FIG. 1 is a block diagram illustrating one embodiment of a monitoring system 2. Monitoring system 2 monitors inputs 4. In one embodiment, monitoring system 2 includes monitor 6 and centralized database storage system 8. Monitor 6 periodically measures the input levels, records the measured input levels as data values, calculates statistical representations of the data values, and transmits the statistical representations to centralized database storage system 8.

In one embodiment, monitor 6 includes meter 10, local storage system 12, processing system 14, and transmitter 16. Meter 10 is any device or system capable of periodically measuring input levels for recordation. In one embodiment, meter 10 includes a voltmeter capable of measuring voltage levels of an input 4. In another embodiment, meter 10 includes an ammeter capable of measuring current levels of an input 4. In one embodiment, meter 10 is configured to simultaneously measure a plurality of input levels.

Local storage system 12 is configured to record the measured input levels as data values. Local storage system 12 is any device or system configured to store data or executable code. Local storage system 12 may also be a program storage system tangibly embodying a program, applet, or instructions executable by processing system 14 for performing the method steps of the present invention executable by processing system 14. Local storage system 12 may be any type of storage media such as magnetic, optical, or electronic storage media.

Local storage system 12 is illustrated in FIG. 1 as a single device. Alternatively, storage system 12 may include more than one device. Furthermore, each device of storage system 12 may be embodied in a different media type. For example, one device of storage system 12 may be a magnetic storage media while another device of storage system 12 is an electronic storage media.

Processing system 14 is any combination of hardware and executable code configured to calculate statistical representations of the data values. In one embodiment, processing system 14 is configured to periodically calculate statistical representations of the data values. In one embodiment, the statistical representations of the data values include a mean and a standard deviation of the data values.

Transmitter 16 is any device or system for transmitting the statistical representations. In one embodiment, transmitter 16 is configured to transmit the statistical representations to centralized database storage system 8. In one embodiment, transmitter 16 is configured to periodically transmit the statistical representations.

Centralized database storage system 8 is any device or system capable of receiving the statistical representations from monitor 6. In one embodiment, centralized database storage system 8 includes receiver 18, storage system 20, processing system 22, report generator 24, and user interface 26. Receiver 18 is any device or system capable of being configured to receive transmitted statistical representations. Processing system 22 is any combination of hardware and executable code configured to process executable code.

Storage system 20 is configured to record the measured input levels as data values. Storage system 20 is any device or system configured to store data or executable code. Storage system 20 may also be a program storage system tangibly embodying a program, applet, or instructions executable by processing system 22 for performing the method steps of the present invention executable by processing system 22. Storage system 20 may be any type of storage media such as magnetic, optical, or electronic storage media.

Storage system 20 is illustrated in FIG. 1 as a single device. Alternatively, storage system 12 may include more than one device. Furthermore, each device of storage system 12 may be embodied in a different media type. For example, one device of storage system 12 may be a magnetic storage media while another device of storage system 12 is an electronic storage media.

Report generator 24 is any device or system configurable to generate a report about the input levels, from the statistical representations. In one embodiment, report generator 24 is embodied with processor 22 and storage system 20. In one embodiment, the report is generated from statistical representations transmitted to centralized database storage system 8.

User interface 26 is any device or system configurable to display the report to a user. For examples of user interface 26 include a computer monitor and a printer.

In one embodiment, monitoring system 2 further includes communication relay device 28. In this embodiment, transmitter 16 transmits the statistical representations to communication relay device 28. Communication relay device 28 then retransmits the statistical representations to centralized database storage system 8.

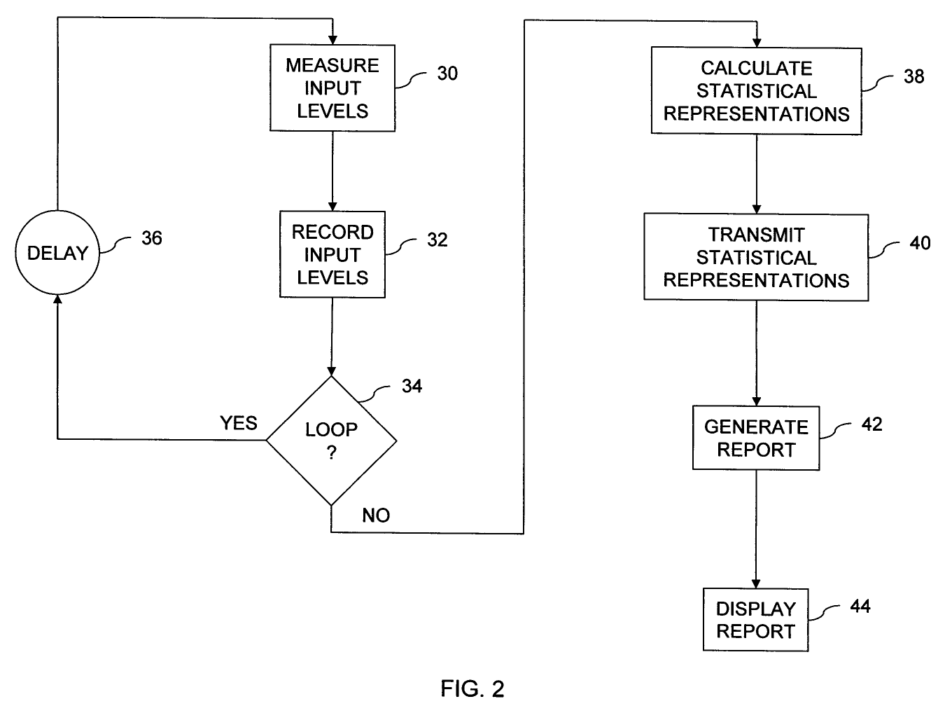

FIG. 2 is a flow chart representing steps of one embodiment of the present invention. Although the steps represented in FIG. 2 are presented in a specific order, the present invention encompasses variations in the order of steps. FIG. 2 illustrates some of these possible variations. Furthermore, additional steps may be executed between the steps illustrated in FIG. 2 without departing from the scope of the present invention.

Input levels are measured 30 and recorded 32 as data values. The input levels may be measured periodically by looping 34 with or without an added time delay 36 in between measurements. In one embodiment, a plurality of input levels are measured simultaneously.

After the input levels are measured 32 and recorded 34, statistical representations of the data values are calculated 38. In one embodiment, calculating 38 statistical representations of the data values includes periodically calculating statistical representations of the data values. In one embodiment, calculating statistical representations of the data values includes calculating a mean and a standard deviation of the data values.

The statistical representations are then transmitted 40. In one embodiment, the statistical representations are transmitting 40 to centralized database storage system 8 and may be transmitted to centralized database storage system 8 periodically.

In one embodiment, transmitting 40 the statistical representations to centralized database storage system 8 includes transmitting the statistical representations to communication relay device 28 and retransmitting the statistical representations from communication relay device 28 to centralized database storage system 8

A report may be generated 42 from the statistical representations. In one embodiment, the report is generated 42 from the statistical representations transmitted to centralized database storage system 8. The report is displayed 44 to a user. The user may use the report to evaluate the suitability of the levels of the inputs.

In one use of the present invention, monitor 6 is installed in a remote location for use in monitoring a cathodic protection system. Monitor 6 periodically measures and records one or more useful voltage or current levels associated with the cathodic protection system. Statistical representations of those levels are calculated and transmitted to a satellite or other communication relay and then retransmitted to centralized database storage system 8. A report is then generated for a user. The user evaluates the report to ascertain whether the cathodic protection system is functioning properly.

One significant advantage of the present invention is that statistical representations of periodically measured input values provide a user with a more accurate representation of the functionality of the cathodic protection system than a single data point.

The foregoing description is only illustrative of the invention. Various alternatives, modifications, and variances can be devised by those skilled in the art without departing from the invention. Accordingly, the present invention embraces all such alternatives, modifications, and variances that fall within the scope of the described invention.

What is claimed is:

1. A method for monitoring input levels, the method comprising:
periodically measuring the input levels,
recording the measured input levels as data values,
calculating statistical representations of the data values, and
transmitting the statistical representations to a centralized database storage system.

2. The method of claim 1 further including:
generating a report about the input levels, from the statistical representations and
displaying the report to a user.

3. The method of claim 2 wherein the report is generated from the statistical representations transmitted to the centralized database storage system.

4. The method of claim 1 wherein periodically measuring the input levels includes simultaneously measuring a plurality of input levels.

5. The method of claim 1 wherein calculating statistical representations of the data values includes periodically calculating statistical representations of the data values.

6. The method of claim 1 wherein calculating statistical representations of the data values includes calculating a mean and a standard deviation of the data values.

7. The method of claim 1 wherein transmitting the statistical representations to a centralized database storage system includes periodically transmitting the statistical representations.

8. The method of claim 1 wherein transmitting the statistical representations to a centralized database storage system includes:
transmitting the statistical representations to a communication relay device and
retransmitting the statistical representations from the communication relay device to the centralized database storage system

9. An input level monitoring system comprising:
a meter configured to periodically measure the input levels,
a local storage system configured to record the measured input levels as data values,
a processing system configured to calculate statistical representations of the data values, and
a transmitter configured to transmit the statistical representations.

10. The monitoring system of claim 9 further including a centralized database storage system and wherein the transmitter is configured to transmit the statistical representations to the centralized database storage system.

11. The monitoring system of claim 10 further including a communication relay device and wherein the transmitter is further configured to transmitting the statistical representations to the communication relay device and wherein the communication relay device is configured to retransmit the statistical representations to the centralized database storage system.

12. The monitoring system of claim 10 further including:
a report generator configured to generate a report about the input levels, from the statistical representations and
a user interface configured to display the report to a user.

13. The monitoring system of claim 12 wherein the report is generated from statistical representations transmitted to the centralized database storage system.

14. The monitoring system of claim 9 the meter is further configured to simultaneously measure a plurality of input levels.

15. The monitoring system of claim 9 wherein the processing system is further configured to periodically calculate statistical representations of the data values.

16. The monitoring system of claim 9 wherein the statistical representations of the data values include a mean and a standard deviation of the data values.

17. The monitoring system of claim 9 wherein the transmitter is further configured to periodically transmit the statistical representations.

18. A program storage system readable by a computer, tangibly embodying a program, applet, or instructions executable by the computer to perform method steps for monitoring input levels, the method comprising:
periodically measuring the input levels,
recording the measured input levels as data values,
calculating statistical representations of the data values, and
transmitting the statistical representations to a centralized database storage system.

19. The program storage system of claim 18 further including:
generating a report about the input levels, from the statistical representations and
displaying the report to a user.

20. The program storage system of claim 19 wherein the report is generated from the statistical representations transmitted to the centralized database storage system.

21. The program storage system of claim 18 wherein periodically measuring the input levels includes simultaneously measuring a plurality of input levels.

22. The program storage system of claim 18 wherein calculating statistical representations of the data values includes periodically calculating statistical representations of the data values.

23. The program storage system of claim 18 wherein calculating statistical representations of the data values includes calculating a mean and a standard deviation of the data values.

24. The program storage system of claim 18 wherein transmitting the statistical representations to a centralized database storage system includes periodically transmitting the statistical representations.

25. The program storage system of claim 18 wherein transmitting the statistical representations to a centralized database storage system includes:
transmitting the statistical representations to a communication relay device and
retransmitting the statistical representations from the communication relay device to the centralized database storage system.
